(19) United States
(12) Patent Application Publication
(10) Pub. No.: US 2026/0012275 A1
(43) Pub. Date: Jan. 8, 2026

(54) DYNAMIC RELAY SELECTION METHOD FOR WIRELESS COMMUNICATION SYSTEM AND COMMUNICATION DEVICE

(71) Applicant: OPEN ROAD SOLUTIONS, INC., Hsinchu City (TW)

(72) Inventors: CHING-TSAI CHOU, Hsinchu City (TW); CHENG-YI WANG, Hsinchu City (TW)

(73) Assignee: OPEN ROAD SOLUTIONS, INC., Hsinchu City (TW)

(21) Appl. No.: 18/764,706

(22) Filed: Jul. 5, 2024

(51) Int. Cl. H04H 20/02; H04W 16/26

(52) U.S. Cl. CPC H04H 20/02; H04W 16/26

(57) ABSTRACT

A dynamic relay selection method for wireless communication system is provided, to a wireless communication group including multiple devices, comprising: a first device in the group receives beacon signals from multiple devices in the group, wherein each beacon signal includes an identity (ID) of a device transmitting the beacon signal and at least one of a device coverage of the device and an extending coverage of the device; the first device selects device(s) from the multiple devices in the group based on device coverages or extending coverages of the multiple devices in the group; and the first device broadcasts a first voice message, wherein the first voice message includes a voice packet and assignment information and the assignment information indicates the selected device(s) for relaying or forwarding the voice packet.

### FIELD OF THE INVENTION

The present invention relates generally to a packet relay selection method, and more particularly, to a dynamic relay selection method for wireless communication system.

### BACKGROUND OF THE INVENTION

Wireless communication has long been a preferred choice of communication since its inception. However, it is only until the last few decades, the wireless communication has been fully explored and utilized to actually application due to the advance of related enabling technologies. More specifically, each new generation of wireless communications creates more sophisticated capabilities to allow users more flexibility. As a result, users can now connect to resources from anywhere, and mobile devices have become more powerful and versatile, giving users the opportunity to complete complex tasks.

One of the most prominent exemplars is the ubiquitous usage of modern smart phone, which demands additional communication capabilities to meet various needs, such as Bluetooth communication accessories. An emerging popular application is the usage of Bluetooth headsets for outdoor activities, such as motorcycle ridings. Many motorcycle enthusiasts go on group ridings. However, differences in individual speed and road conditions can lead to incremental distances between group members. Therefore, the audio real-time communication between individuals becomes necessary for the group members to share and coordinate various information, such as, real-time road conditions, emergencies, or sudden changes in planned routes.

Wireless communication relies on broadcasting for transmission of information, such as audio, video, or data, and is widely used in various applications, including radio and television broadcasting, Wi-Fi, Bluetooth, cellular networks, and many more. Moreover, in current wireless communication systems, relaying is a technology to achieve a broader coverage of the broadcast information, as well as extending the coverage distance. Nevertheless, the conventional broadcast/relay technologies would take up much bandwidth and greatly reduce the communication efficiency of the system. Take the aforementioned motorcycle headset as an example, some noticeable drawbacks of the Bluetooth technology include the limited communication range and lack of sufficient bandwidth to accommodate a large number of group members.

It is therefore imperative to devise a smart broadcast/relay protocol to address these issues to make wireless communication devices more convenient and reliable.

### SUMMARY OF THE INVENTION

A primary objective of the present invention is to provide a dynamic relay selection method for wireless communication system, able to dynamically collect and compute information to relay received broadcast data so as to provide larger coverage of the wireless communication system.

Another objective of the present invention is to provide a dynamic relay selection method for wireless communication system, able to effectively improve the bandwidth utilization of the wireless communication system to accommodate a larger number of devices.

To achieve the aforementioned objective, the present invention provides a dynamic relay selection method for wireless communication system, wherein there are multiple devices in a group, comprising: a first device in the group receives beacon signals from multiple devices in the group, wherein each beacon signal includes an identity (ID) of a device transmitting the beacon signal and at least one of a device coverage of the device and an extending coverage of the device; the first device selects device(s) from the multiple devices in the group based on device coverages or extending coverages of the multiple devices in the group; and the first device broadcasts a first voice message, wherein the first voice message includes a voice packet and assignment information and the assignment information indicates the selected device(s) for relaying or forwarding the voice packet.

In a preferred embodiment, the wireless communication system is a time division multiplex broadcasting (TDMB) communication system.

In a preferred embodiment, the device coverage of the device indicates the device itself and other devices in the group from which the device receives beacon signals.

In a preferred embodiment, a minimum number of devices are selected for relaying or forwarding the voice packet to maximize the coverage of the voice packet transmission.

In a preferred embodiment, the voice packet is generated by the first device or included in a second voice message received from a second device and the second voice message further includes second assignment information indicating the first device for relaying or forwarding the voice packet.

In a preferred embodiment, each beacon signal further includes an ID of the group.

In a preferred embodiment, each beacon signal may include an extending coverage which is a union of the device coverage of a device transmitting the beacon signal and all device coverages received from neighboring devices i.e. the extending coverage of the device indicates devices that are reachable by two-hops of the device. It is also feasible that the extending coverage of the device may be extended to indicate devices that are reachable by more than two-hops of the device. In another preferred embodiment, each beacon signal may also include an overall coverage which is a union of the extending coverage of a device transmitting the beacon signal and all extending coverages received from neighboring devices.

In a preferred embodiment, the present invention further comprises: the first device determines a timing for broadcasting its beacon signal according to at least the overall coverages received from neighboring devices.

In a preferred embodiment, wherein all current devices in the group are indicated in the overall coverage of the first device.

In a preferred embodiment, each device coverage or each extending coverage may be a string of bits and each bit in the string indicates whether or not a corresponding device exists in the device coverage or the extending coverage. In another preferred embodiment, the assignment information may be a string of bits and each bit in the string indicates whether or not a corresponding device is selected or assigned.

The present invention also provides a communication device, comprising: a control circuit; a processor installed in the control circuit; a memory installed in the control circuit and coupled to the processor; wherein the processor is configured to execute a program code stored in the memory to perform the method steps as defined in anyone of the preceding claims.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a schematic view of a wireless communication system applicable for the present invention;

FIG. 2 shows a flowchart of the dynamic relay selection method for wireless communication system according to the present invention;

FIG. 3 shows a schematic view of data structure for a beacon signal and a voice message of an exemplary TDMB communication system;

FIG. 4 shows a schematic view of the present invention in actual application, wherein the wireless communication system includes the exemplary system of FIG. 1 and additional devices; and

FIG. 5 shows a schematic view of the structure of a communication device of the present invention.

### DETAILED DESCRIPTION OF THE INVENTION

The accompanying drawings are included to provide a further understanding of the invention, and are incorporated in and constitute a part of this specification. The drawings illustrate embodiments of the invention and, together with the description, serve to explain the principles of the invention. The terminology used herein is for the purpose of describing particular embodiments only and is not intended to limit the present invention. As used herein, the term “and/or” includes any and all combinations of one or more of the associated listed items.

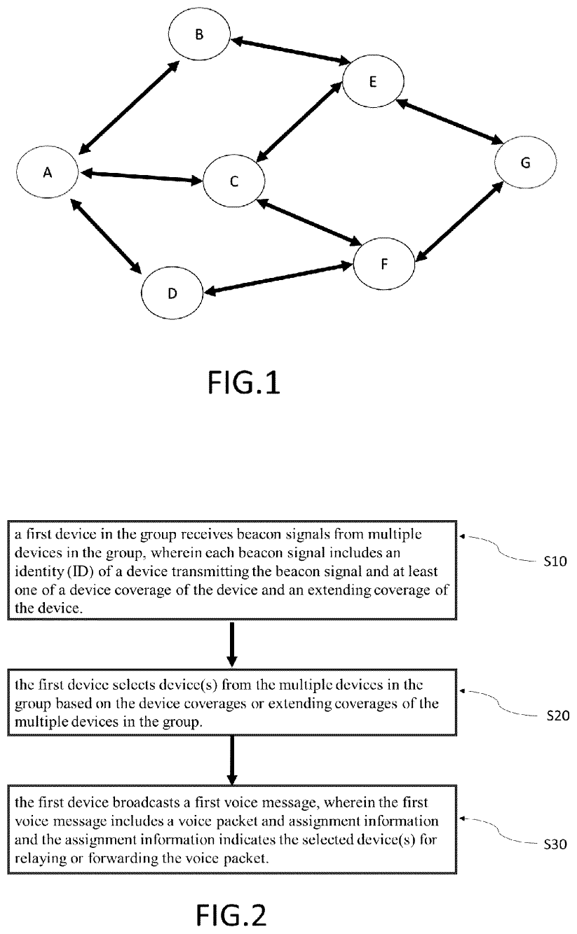

FIG. 1 shows a schematic view of a wireless communication system applicable for the present invention. FIG. 2 shows a flowchart of the dynamic relay selection method for wireless communication system according to the present invention. As shown in FIG. 1 the applicable wireless communication system includes a plurality of devices forming a group, and the devices are labelled as A, B, . . . , G, respectively. As shown in FIG. 2, the dynamic relay selection method for wireless communication system of the present invention includes the following steps:

In step S10, a first device in the group receives beacon signals from multiple devices in the group, wherein each beacon signal includes an identity (ID) of a device transmitting the beacon signal and at least one of a device coverage of the device and an extending coverage of the device.

It should be explained that the device coverage of each device indicates the devices that are directly covered by the transmitting device, i.e., able to receive the beacon signal from the transmitting device. For example, in FIG. 1, the beacon signal sent out by the device A would include the ID field containing A and the device coverage field indicating B, C, D. It is worth noting that the device coverage of each device is dynamic, i.e., changeable, due to the distance change between devices so that one device that is covered by another device can fall out of the coverage range or come into within coverage range, and vice versa. In a preferred embodiment, a string of bits may be used to represent a device coverage and each bit in the string indicates whether or not a corresponding device exists in the device coverage. The order of devices in the device coverage may be the same as the order of beacon signals transmitted by devices in a period of beacon signal transmission. For example, a string of 8 bits may be used to indicate a device coverage with a maximum number of 8 devices. A device coverage of ‘10010000’ indicates device 0 and device 3 are present.

In step S20, the first device selects device(s) from the multiple devices in the group based on the device coverages or extending coverages of the multiple devices in the group.

It should be noted that each device may further maintain an extending coverage and include it in the beacon signal transmitted by the device. The extending coverage maintained by each device include the devices in the device coverage of this device plus all devices in the device coverages of those devices in the device coverage of this device. In other words, the extending coverage includes the devices that are reachable by two-hops of the first device. Specifically, the extending coverage is defined as by merging the device coverage of a device transmitting the beacon signal and all the device coverages received from neighboring devices. In a preferred embodiment, the extending coverage information can be obtained by taking the union of the device coverage of a device and those device coverages of its neighboring devices. In a preferred embodiment, a string of bits may be used to represent an extending coverage and each bit in the string indicates whether or not a corresponding device exists in the extending coverage. The order of devices in the extending coverage may be the same as the order of beacon signals transmitted by devices in a period of beacon signal transmission. However, the present invention is not limited thereto. In other embodiments, the number of hops to be included in the extending coverage can be further extended.

Take the wireless communication system in FIG. 1 as an example, the device coverage of each device in the group is shown as follows:
Device coverage of device A=[B, C, D];
Device coverage of device B=[A, E];
Device coverage of device C=[A, E, F];
Device coverage of device D=[A, F];
Device coverage of device E=[B, C, G];
Device coverage of device F=[C, D, G];
Device coverage of device G=[E, F].

Accordingly, the extending coverage for each device in the group can be computed to obtain as follows:
Extending coverage of device A=[B,C,D]∪[A,E]∪[A,E,F]∪[A,F]∪=[A,B,C,D,E,F];
Extending coverage of device B=[B,C,D]∪[A,E]∪B,C,G]=[A,B,C,D,E,G];
Extending coverage of device C=[B,C,D]∪[A,E,F]520 [B,C,G]∪[C,D,G]=[A,B,C,D,E,F,G];
Extending coverage of Device D=[B,C,D]∪[A,F]∪[C,D,G]∪=[A,B,C,D,F,G];
Extending coverage of Device E=[A,E]∪[A,E,F]∪[B,C,G]∪[E,F]∪=[A,B,C,E,F,G];
Extending coverage of device F;=[A,E,F]∪[A,F]∪[C,D,G]∪[E,F]520 =[A,C,D,E,F,G];
Extending coverage of device G=[B,C,G]∪[C,D,G]∪[E,F]∪=[B,C,D,E,F,G].

Therefore, in step S20, the selection of the devices may be based on device coverages of neighboring devices of the first device i.e. the extending coverage of the first device.

In step S30, the first device broadcasts a first voice message, wherein the first voice message includes a voice packet and assignment information and the assignment information indicates the selected device(s) for relaying or forwarding the voice packet.

In a preferred embodiment, a string of bits may be used to represent the assignment information and each bit in the string indicates whether or not a corresponding device is selected or assigned. The order of devices in the assignment information may be the same as the order of beacon signals transmitted by devices in a period of beacon signal transmission.

It should be noted that the devices in the group broadcast a beacon signal to indicate the beginning of a sequence of information and data, including but not limited to a device ID, a device coverage, an extending coverage, and so on. As described earlier, the device coverage of the device indicates the device itself and all other device(s) from which the device receives beacon signals, and the extending coverage indicates the devices reachable by at least two hops. It should be also noted that the beacon signal may further include a group ID, so as to distinguish different groups if there are multiple groups with overlapping coverage ranges.

Specifically, as shown in step S30, the voice packet relaying or forwarding may be based on the extending coverage of the first device or the device coverages of its neighboring devices. When a device broadcasts a voice packet, the device can assign which device(s) in its device coverage to relay or forward the voice packet and label the selected devices as the assignment information to be transmitted along the voice packet. As there is no need for all receiving devices in the device coverage to relay the received voice packet, it is, therefore preferably, to select only minimum number of devices so that the relayed voice packet can reach the devices in the group as more as possible, in other words, to hopefully achieve a complete coverage of all devices in the group.

The selection, i.e., the assignment of devices to relay voice packets, can be further executed according to an overall coverage. Therefore, each device also maintains the overall coverage to include all the devices within the group that are reachable by the device directly or indirectly. In other words, the overall coverage includes all the devices that are reachable by the device regardless how many hops does it take to reach. In other words, the overall coverage can be considered as a further extension on the aforementioned extending coverage, without the two-hop limitation.

In a preferred embodiment, the beacon further includes an overall coverage field, and then the overall coverage can be computed by taking the union of all the extending coverages in the received beacons.

On the other hand, the voice packet is generated by the first device or included in a second voice message received from a second device and the second voice message further includes second assignment information indicating the first device for relaying or forwarding the voice packet. As such, the relaying of the voice packets will propagate to achieve the complete coverage of the group members, i.e., the effect of broadcasting.

It should be noted that the dynamic relay selection method of the present invention must define a time duration for each device to receive all the beacon signals from the neighboring devices in the group. Preferably, the present invention further comprises: the first device determines a timing for broadcasting its beacon signal according to at least the overall coverages received from neighboring devices. In a preferred embodiment, all current devices in the group are indicated in the overall coverage of the first device.

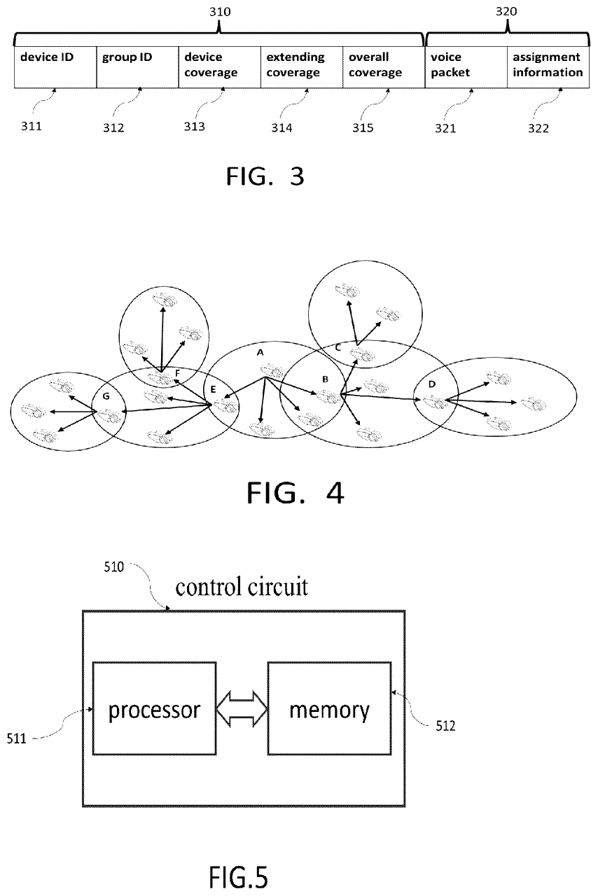

The dynamic relay selection method of the present invention is applicable to any time-division based wireless communication system. For example, the wireless communication system can be a time division multiplex broadcasting (TDMB) communication system. FIG. 3 shows a schematic view of data structure for a beacon signal and a voice message of the TDMB communication system. As shown in FIG. 3, the beacon signal 310 includes a device ID 311, a group ID 312, a device coverage 313, an extending coverage 314, and an overall coverage 315. The voice message 320 includes a voice packet 321 and an assignment information 322.

Using the exemplar in FIG. 1, when the device A receives a voice message 320, the device A selects devices from its device coverage based on the device coverages 313 or the extending coverages 314 received from neighboring devices, and finally the device A broadcasts a first voice message 320, wherein the first voice message includes a voice packet 321 and assignment information 322. As the assignment information indicates the selected device(s) for relaying or forwarding the voice packet, the assignment information is a sub-set of the device coverage of device A.

FIG. 4 shows a schematic view of the present invention in actual application, wherein the wireless communication system includes the exemplary system of FIG. 1 and additional devices. As shown in FIG. 4, at a snapshot during the riding, the speaker device (i.e., device A) transmits a voice packet and assigns devices B and E for relaying. The devices B and E further forward the voice packet and assign the devices C and D and the devices F and G respectively for relaying. Finally, the devices C, D, F, and G perform the last voice packet forwarding. As a result, all devices in the group can receive the voice packet of the initial broadcaster (i.e. device A).

The present invention also provides a communication device, as shown in FIG. 5, comprising: a control circuit 510; a processor 511 installed in the control circuit 510; a memory 512 installed in the control circuit 510 and coupled to the processor 511, wherein the processor 511 is configured to execute a program code stored in the memory 512 to perform the aforementioned method.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A dynamic relay selection method for wireless communication system, wherein there are multiple devices in a group, comprising:
a first device in the group receives beacon signals from multiple devices in the group, wherein each beacon signal includes an identity (ID) of a device transmitting the beacon signal and at least one of a device coverage of the device and an extending coverage of the device;
the first device selects device(s) from the multiple devices in the group based on the device coverages or the extending coverages of the multiple devices in the group; and
the first device broadcasts a first voice message, wherein the first voice message includes a voice packet and an assignment information and the assignment information indicates the selected device(s) for relaying or forwarding the voice packet.

2. The method of claim 1, wherein the wireless communication system is a time division multiplex broadcasting (TDMB) communication system.

3. The method of claim 1, wherein the device coverage of the device indicates the device itself and other devices from which the device receives beacon signals.

4. The method of claim 1, wherein the extending coverage of the device indicates devices that are reachable by two-hops of the device.

5. The method of claim 4, wherein the devices that are reachable by two-hops of the device include devices in the device coverage of the device and devices in the device coverages of those devices in the device coverage of the device.

6. The method of claim 1, wherein the extending coverage of the device indicates devices that are reachable by more than two-hops of the device.

7. The method of claim 1, wherein a minimum number of devices are selected for relaying or forwarding the voice packet to maximize the coverage of the voice packet transmission.

8. The method of claim 1, wherein the voice packet is generated by the first device or included in a second voice message received from a second device and the second voice message further includes second assignment information indicating the first device for relaying or forwarding the voice packet.

9. The method of claim 1, wherein each beacon signal further includes an ID of the group.

10. The method of claim 4, wherein each beacon signal further includes an overall coverage which is a union of the extending coverage of the device transmitting the beacon signal and all extending coverages received from neighboring devices.

11. The method of claim 10, further comprising:
the first device determines a timing for broadcasting its beacon signal according to at least the overall coverages received from neighboring devices.

12. The method of claim 11, wherein all current devices in the group are indicated in an overall coverage of the first device.

13. The method of claim 6, wherein each beacon signal further includes an overall coverage which is a union of the extending coverage of the device transmitting the beacon signal and all extending coverages received from neighboring devices.

14. The method of claim 13, further comprising:
the first device determines a timing for broadcasting its beacon signal according to at least the overall coverages received from neighboring devices.

15. The method of claim 14, wherein all current devices in the group are indicated in an overall coverage of the first device.

16. The method of claim 1, wherein each device coverage or each extending coverage is a string of bits and each bit in the string indicates whether or not a corresponding device exists in the device coverage or the extending coverage.

17. The method of claim 1, wherein the assignment information is a string of bits and each bit in the string whether indicates whether or not a corresponding device is selected or assigned.

18. A communication device, comprising:
a control circuit;
a processor installed in the control circuit;
a memory installed in the control circuit and coupled to the processor;
wherein the processor is configured to execute a program code stored in the memory to perform the method steps as defined in claim 1.
